(19) United States
(12) Patent Application Publication
(10) Pub. No.: US 2011/0050879 A1
(43) Pub. Date: Mar. 3, 2011

(54) OPTICAL INSPECTION SYSTEM EMPLOYING SHORT WAVE INFRARED SENSING

(75) Inventor: Yeu-Hwa SHYY, Mason, OH (US)

(73) Assignee: PHILIP MORRIS USA INC., Richmond, VA (US)

(21) Appl. No.: 12/710,227

(22) Filed: Feb. 22, 2010

Related U.S. Application Data
(60) Provisional application No. 61/154,192, filed on Feb. 20, 2009.

(51) Int. Cl. H04N 7/18; G06K 9/00

(52) U.S. Cl. 348/88; 382/141; 348/E07.085

(57) ABSTRACT

A system for inspecting cigarette paper containing banded regions and non-banded regions. The system includes a short wave infrared camera, the short wave infrared camera forming electrical signals representing properties of the cigarette paper and a processor for analyzing the electrical signals to provide analysis results, the processor including logic for successively examining pixels to determine whether each successive pixel corresponds to a non-banded region or a banded region; logic for computing spacing between adjacent banded regions on the cigarette paper based on results provided by the logic for successively examining; and logic for computing width of banded regions on the cigarette paper based on results provided by the logic for successively examining. An online method for inspecting paper containing banded regions and non-banded regions is also provided.

### RELATED APPLICATION

This patent application claims the benefit of Provisional Application Ser. No. 61/154,192, filed on Feb. 20, 2009, directed to an optical inspection system employing short wave infrared sensing, which is hereby incorporated by reference in its entirety.

### FIELD

This document relates generally to a system and method for inspecting a paper containing bands.

### Working Environment

It is often desirable in the papermaking art to alter or enhance the characteristics of paper. For example, cigarette manufacturers have long appreciated the usefulness of adding flavorings or burn control additives to paper. Another more recent application includes altering cigarette paper so that smoking articles incorporating such paper have a reduced burn rate when the smoking article is not drawn on by the smoker.

Many techniques have been developed for altering or enhancing the characteristics of paper. Such techniques include the imprinting or coating of paper webs by gravure presses, blade coating, roller coating, silkscreening and stenciling methods. For example, U.S. Pat. No. 4,968,534 describes a stenciling apparatus wherein a continuous stencil comes into facing engagement with a paper web during the application procedure. The pattern applied by the device can be altered by changing the stencil used.

U.S. Pat. No. 4,968,534 describes a moving orifice applicator mounted on a paper making machine. The applicator consists of continuous steel belt mounted on motor-driven pulleys. The lower traverse of the belt's travel forms the bottom of an enclosed cavity. Orifices on the centerline of the belt are in communication with the cavity. During operation, slurry is continuously pumped into the enclosed cavity and motion of the belt across the web causes parallel bands of slurry to be applied to the web as slurry passes from the cavity through the orifices and onto the web. The relative angle of bands applied to the web with respect to the web and their spacing can be easily changed by altering the relative angle and speed of the belt and web.

To assure the quality and consistency of these enhanced papers, systems have been developed to inspect the surface of such papers, including cigarette paper. The inspection may entail projecting electromagnetic radiation on a moving web of material. In such a system, light impinges on the surface of the moving web, where it is reflected and received at a detector device. Any anomalies in the moving web can be detected by investigating the nature of the reflected electromagnetic radiation. For instance, a tear, pinhole or blemish in the web will manifest itself in a spike in the signal level from the detector, which is attributed to an increase or decrease in reflected radiation. This spike can be viewed by connecting the detector output to an oscilloscope or other output device.

The inspection of cigarette paper presents significant challenges. Referring to FIG. 1, a cigarette 10 is shown that includes a cigarette paper 12 containing a plurality of bands 14 formed by depositing a layer of cellulosic pulp, or other material, on the base cigarette paper 12. FIG. 2 shows a section of cigarette paper containing these bands. Bands formed on cigarette paper often have reflective properties similar to the cigarette paper itself. Often, for instance, the bands are formed of white colored material that is difficult to distinguish from the white colored cigarette paper. Moreover, the basis weight of a cigarette paper may vary along the length of the paper, due to the difficulty in maintaining a constant pulp application rate during the manufacture of the paper. The variance in basis weight of the paper influences its reflective properties, thereby obfuscating the differences between banded and non-banded regions. Certain known devices do not have the ability to interpret a reflection from a web of this nature.

Also, with reference to FIG. 2, the operator may be interested in determining whether the width 16 of the bands, contrast of the bands, and distance 18 between bands is within proper tolerances. Whether a band width is too long, too short, or separated from its neighboring band by more or less than a desired distance cannot be determined by simply observing the properties of a single point on a moving web. Rather, the spatial relationship between different elements on the web must be determined.

Pattern recognition techniques are one way of determining the spatial relationship between different features on a printed web of material. In a common technique, a camera forms a digital image of a portion of a web of material and information printed thereon. The digital image is then compared with a pre-stored template representing an error-free web portion. Discrepancies between the template and the image represent an irregular web. These techniques offer accuracy, but unfortunately entail a great deal of data processing. These techniques are therefore ill-suited for the task of detecting the properties of bands on a web moving at high speeds.

Rewind/inspection machines for inspecting the surface of a cigarette paper have also been developed. Several of these machines suffer a number of drawbacks. For example, certain of these machines can apply considerable tension to the web of material as it passes from the unwind bobbin to the rewind bobbin, and are therefore ill-suited for particularly fragile sheet-like material. Since cigarette paper is relatively weak, it can be difficult to rewind a large bobbin at high speeds without breakage. Also, cigarette paper is relatively thin, making it difficult to evenly and cleanly rewind the paper onto the rewind bobbin.

U.S. Pat. No. 5,966,218 describes a rewinder machine that optically inspects banded paper by directing an elongated beam of light laterally across the paper. The elongated beam impinges the surface of the paper and forms reflections. A line scan camera containing a linear CCD array receives the reflections and generates output signals. A line scan processor processes the output signals to generate data indicative of the spacing between bands, the width of the bands, and the contrast of the bands. After being inspected by the camera, the paper is rewound on a rewind bobbin. Various mechanical features of the rewind machine are said to allow rapid mounting and removal of bobbins of paper, and provide for high speed operation.

Although systems have been proposed for inspecting a web of material, such as cigarette paper, that has been manufactured and taken off-line, it would be desirable to provide a system for inspecting imprinted or coated webs on-line, wherein the imprinted or coated has not yet reached a fully dried state.

It has been recently discovered and disclosed in U.S. patent application Ser. No. 12/153,783, filed May 23, 2008, that if one or more layers of aqueous add-on material comprising chalk (calcium carbonate) and starch are applied to a base web and allowed to dry, there may be insufficient contrast between the dried layers and the base web using the techniques of U.S. Pat. No. 5,966,218. This problem has been addressed by adding an over-layer of add-on material having little or no chalk content, so as to create sufficient contrast for inspection purposes. However, this solution requires extra material and/or extra applications or operations.

### SUMMARY

Disclosed herein is a system for analyzing the properties of a paper. In the context of cigarette paper, the system can detect the spacing of bands, the width of the bands, and the contrast of the bands.

More specifically, in the inspection system according to exemplary aspects, the paper is passed over an inspection roller where it is illuminated by a light distribution assembly. Specifically, the light distribution assembly directs a stripe of light across the web. In one form, the stripe of light is reflected at the paper surface and then received at a short wave infrared line scan camera containing a linear charge coupled device (CCD) array. In another form, the stripe of light is transmitted through the paper surface and then received on the other side by the short wave infrared line scan camera containing a linear CCD array.

The data from the CCD array is fed to a line scan processor. The line scan processor divides the data into a plurality of lanes. A single pixel from each lane is then compared with a variable threshold value to determine whether the lane corresponds to a band region or a non-band region. The pixel chosen within each lane changes from scan line to scan line to define a zig-zag pattern. By monitoring and recording successive pixels from each lane, the line scan processor is able to independently compute for each lane the width of bands on the web, the spacing between bands, and the average contrast of the bands.

The threshold used to discriminate band regions from non-band regions is dynamically set on the basis of moving averages of immediately preceding band regions and non-band regions. In one form, the threshold represents the moving average of non-band background plus the greater of: (1) a set constant value (such as 10 gray levels) or (2) 50% of the moving average of banded region peak heights (where the “peak heights” correspond to the gray level of the banded region minus the gray level of a neighboring non-banded region). Dynamically setting the threshold in this manner accommodates a wide variety of different types of cigarette paper and band material, and also can account for changes in the basis weight of the paper along the length of the paper.

On periodic intervals, the information calculated by the line scan processor is assembled into an Ethernet packet and transferred over an Ethernet network to a computer workstation. The computer workstation then aggregates the packet with previously received packets and displays various summary statistical displays for the operator. For instance, the display provides graphs illustrating the band width, band spacing, band contrast, and band anomalies as a function of lane number for a reporting interval. Furthermore, the display presents cumulative statistics by presenting a graph of the band width, band spacing and band contrast as a function of time.

As such, in one aspect, provided is a system for inspecting cigarette paper containing banded regions and non-banded regions. The system includes a short wave infrared camera, the short wave infrared camera forming electrical signals representing properties of the cigarette paper and a processor for analyzing the electrical signals to provide analysis results, the processor including logic for successively examining pixels to determine whether each successive pixel corresponds to a non-banded region or a banded region; logic for computing spacing between adjacent banded regions on the cigarette paper based on results provided by the logic for successively examining; and logic for computing width of banded regions on the cigarette paper based on results provided by the logic for successively examining.

In one form, the short wave infrared camera includes indium gallium arsenide sensors.

In another form, the system includes an encoder for sensing a web speed.

In another aspect, provided is a system for inspecting cigarette paper containing banded regions and non-banded regions. The system includes a short wave infrared camera, said short wave infrared camera forming electrical signals representing properties of said cigarette paper and a processor for analyzing the electrical signals to provide analysis results, the processor including logic for dividing the electrical signals of the camera into a plurality of lanes, and examining electrical signals within each output lane to determine whether the electrical signals are above or below a threshold, wherein electrical signals above the threshold are indicative of the banded regions, and electrical signals below the threshold are indicative of the non-banded regions of the cigarette paper.

In a further aspect, a source of infra red light is provided, the source of infra red light and short wave infrared camera being mutually arranged downstream of an applicator that deposits add-on material for forming the banded regions, to enable the detection of differences in reflectance and/or transmission between the banded regions of add-on material, which are in a wet condition, and the non-banded regions, which are free of add-on material.

In yet another aspect, provided is a method for inspecting paper containing banded regions and non-banded regions, including the steps of directing light from a light source to the surface of the paper, the light forming reflections from, or transmissions through, the paper; receiving the reflections or transmissions by a short wave infrared camera to generate output signals; and processing the output signals in a processing module to generate output information representative of one or more of the following properties, width of one or more banded regions, spacing between one or more adjacent sets of banded regions and contrast of one or more banded regions.

In still yet another aspect, provided is an online method for inspecting paper containing banded regions and non-banded regions. The method includes the steps of directing light from a light source to the surface of the paper, the light forming reflections from, or transmissions through, the paper, receiving the reflections or transmissions by a short wave infrared camera to generate output signals, and processing the output signals in a processing module to generate output information representative of one or more of the following properties: width of one or more banded regions, spacing between one or more adjacent sets of banded regions and contrast of one or more banded regions, wherein the processing step further includes the steps of: dividing the output signals of the camera into a plurality of lanes; and examining output signals within each lane to determine whether the output signals are above or below a threshold, wherein output signals above the threshold are indicative of the banded regions, and output signals below the threshold are indicative of the non-banded regions of the cigarette paper.

These and other features will be apparent from the detailed description taken with reference to the accompanying drawings.

### BRIEF DESCRIPTION OF THE DRAWINGS

Further explanation may be achieved by reference to the description that follows and the drawings illustrating, by way of non-limiting examples, various forms, wherein:

FIG. 1 shows an exemplary cigarette containing banded regions;

FIG. 2 shows an exemplary web of cigarette material including bands;

FIG. 3 depicts a simplified schematic illustration of a portion of a papermaking line having an optical inspection system in accordance herewith;

FIG. 4 shows an exemplary line scan camera and associated light distribution assembly;

FIG. 5 shows an inspection roller for use in the optical inspection system of the papermaking line of FIG. 3;

FIG. 6 shows an exploded view of the inspection roller of FIG. 5;

FIG. 7 shows an exemplary electrical/computer configuration for use in the optical inspection system of the papermaking line of FIG. 3;

FIG. 8 shows an exemplary technique for processing data from the line scan camera in accordance herewith;

FIG. 9 illustrates how the system disclosed herein alters the band detection threshold (T) to compensate for the changing baseline of the image;

FIG. 10 shows an exemplary algorithm for determining various properties of the bands imaged by the line scan camera;

FIG. 11 shows an exemplary statistical display of various properties of the bands imaged by the line scan camera;

FIG. 12A depicts a simplified schematic illustration of a portion of a rotogravure line having an optical inspection system in accordance herewith; and

FIG. 12B depicts another simplified schematic illustration of a portion of a rotogravure line having another optical inspection system in accordance herewith.

### DETAILED DESCRIPTION

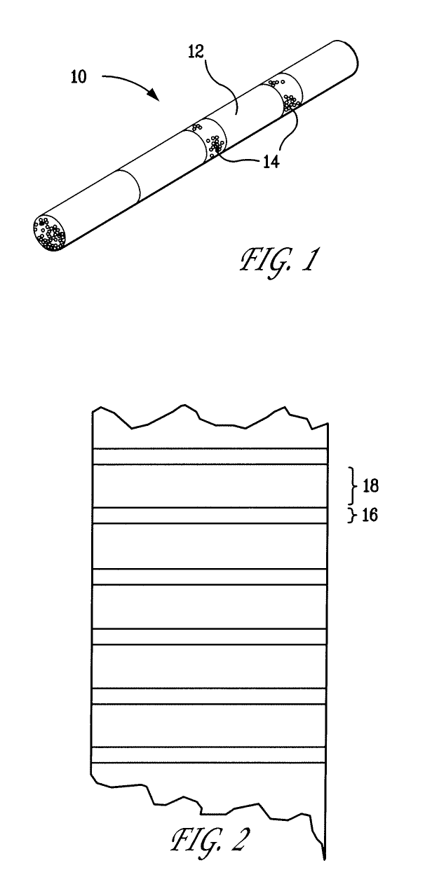

Various aspects will now be described with reference to specific forms selected for purposes of illustration. It will be appreciated that the spirit and scope of the systems and methods disclosed herein are not limited to the selected forms. Moreover, it is to be noted that the figures provided herein are not drawn to any particular proportion or scale, and that many variations can be made to the illustrated forms. Reference is now made to FIGS. 1-11, wherein like numerals are used to designate like elements throughout.

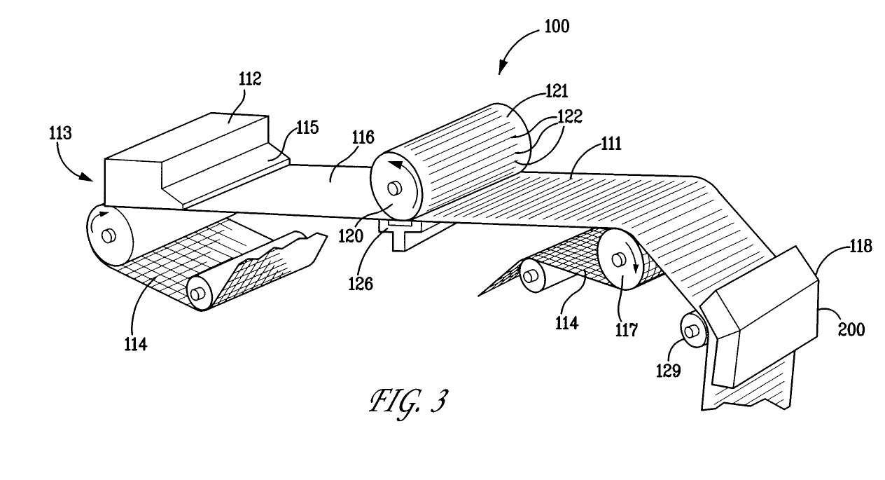

Referring now to FIG. 3, a portion of a papermaking line 100 having an optical inspection system 200 is shown. In particular, FIG. 3 depicts the pulp web-forming area of a conventional Fourdrinier (daubing dandy) papermaking machine 100, adapted to produce a continuous pulp web 116. A headbox 112 is adapted to contain a quantity of cellulosic pulp which is supplied to headbox 112 by a plurality of conduits 113 which communicate with a pulp source (not shown), such as a pulp storage tank.

Placed immediately below headbox 112 is an endless forming wire 114. A slice 115 defined in a lower portion of headbox 112 adjacent to wire 114 permits the pulp from the headbox to flow through slice 115 onto the top surface of the wire 114 to form pulp web 116. Slice 115 is usually of narrow vertical width in order to regulate the amount of pulp which flows from headbox 112. The length of slice 115 typically may extend substantially the entire width of pulp web 116.

The top portion of wire 114 is adapted to move forwardly toward a couch roll 117 and away from slice 115. The direction from headbox 112 toward couch roll 117 is the downstream direction. Once pulp web 116 has been formed, it passes an applicator 120 which deposits additional material onto pulp web 116. As wire 114 begins to move downwardly about couch roll 117 and back toward headbox 112, pulp web 116 is delivered from wire 114 to a plurality of press rolls 118 and then to a dryer section of papermaking machine 100. As pulp web 116 advances in the downstream direction, excess water is permitted to pass through wire 114. A vacuum typically may be applied to at least a portion of the underside of wire 114 to assist in the removal of water from pulp web 116. Couch roll 117 may be adapted to provide a vacuum through wire 114 to the underside of pulp web 116 to remove additional water.

As mentioned above, applicator 20 of the exemplary apparatus 100 deposits additional material onto pulp web 116. In one exemplary form, applicator 120 comprises a hollow rotating drum 121. Rotating drum 121 typically includes a plurality of longitudinal slits 122. In another form, the drum 121 possesses a plurality of troughs (not shown) instead of longitudinal slits 122. As shown, the slits 122 or troughs may be oriented parallel to the longitudinal axis of drum 121. The number of slits 122 or troughs positioned about the drum will, of course, depend upon the radius of the drum and the desired spacing.

In one form, drum 121 is placed in contact with pulp web 116 following formation of web 116 on wire 114. Alternatively, drum 121 is not in physical contact with pulp web 116, but is proximally located so that pulp can stream directly from drum 121 to pulp web 116. The velocity of both drum 121 and pulp web 116 may be substantially synchronized, so that the angular velocity of drum 121 is approximately the same as the linear velocity of pulp web 116. If drum 121 is not physically contacting pulp web 116, the velocities of drum 121 and the pulp web 116 need not be identical. The point at which the material is applied may be at or beyond the point at which the base web has consolidated.

Drum 121 may be supported by rollers protruding from the ends of drum 121. The supporting rollers may, in turn, be supported by a frame (not shown). The frame can be lowered so that the drum is proximally located to pulp web 116 or can contact pulp web 116.

Drum 121 may be rotated by any desired means. In one form, drum 121 frictionally engages pulp web 116, thereby achieving synchronized velocities of both drum 121 and pulp web 116. Alternatively, the drum 121 is rotated by an external drive mechanism. Suitable drive mechanisms are belts, gear trains, and the like. One of ordinary skill in the art may make a selection among the means for rotating a cylindrical body without departing from the scope of this invention.

As stated above, rotating drum 121 may possess a plurality of slits 122 or troughs. Slits 122 may be disposed equidistant to each other about drum 121, although non-uniform spacing between slits may also be employed. In one form, slits 122 are positioned about 5-40 mm apart, measured from the center of one slit to the center of a slit immediately adjacent to it (center-to-center), or about 15-30 mm apart or about 21 mm apart.

Those of skill in the art will understand that the size and shape of the cross-directional regions of increased basis weight will be determined by the shape and dimensions of slits 122. While slits 122 may be rectangular in shape, a selection may be made among various regular and irregular geometric shapes and forms. Additionally, the cross-directional regions may themselves be contiguous or non-contiguous in the cross-direction. Each of slits 122 may have substantially the same dimensions or each of slits 122 may have dimensions of about 1-10 mm or about 1.5-5 mm in width. In one form, the slits 122 are about 2.5 mm wide.

The length of the slits may be at least substantially the same as the circumference of a smoking article, such as a cigarette. However, various slit lengths may be employed

Each of slits 122 acts as a conduit through which material is deposited upon pulp web 116, thereby creating elongated areas of additional material which will become the regions. The flow of material may be regulated so that material does not emanate from more than a single slit 122 at a given time.

The transfer of material from slits 122 to pulp web 116 may be assisted by vacuum applied by vacuum box 126 through wire 114 or by pressurized gas applied through slits 122.

Other apparatus designs and techniques may be employed. For example, a rotogravure-like process may be employed to deposit additional amounts of material on the base web in the cross-direction. In this form, rotating drum 121 contains a plurality of troughs. The troughs are oriented parallel to the longitudinal axis of drum 121. An amount of material substantially the same as the volume of the troughs is placed in each of the troughs by means of a distribution header and metered by means of a doctor blade.

Once one or more troughs have been filled with material, drum 121 is rotated as previously described. Upon contact of a material-laden trough with base web 116, the material is transferred from the troughs to pulp web 116. The transfer of material from the troughs to pulp web 116 may be assisted by vacuum applied by a vacuum box 126 through wire 114 or by pressurized gas applied through the troughs.

The volume of additional material deposited will of course be determined by the volume of the troughs. In one form, the troughs have the dimensions of between about 1-10 mm in width by less than about 3 mm in depth. The length of the troughs should be at a minimum substantially the same as the circumference of a smoking article, such as a cigarette.

Once the additional material has been deposited by the daubing dandy or rotogravure methods, pulp web 116 with the regions 111 may be pressed by a roller means located downstream from the rotating drum. Pulp web 16 is pressed on press rolls (not shown). The pressure employed in the press rolls is comparable to that commonly used for pressing cellulosic pulp web, about 250 pounds per linear inch of the press rolls. In addition to sheet consolidation, water is removed from the sheet by the press rolls.

In another form, a second headbox may be used to deposit additional material directly onto pulp web 116 or on a top wire that contacts the top of pulp web 116 instead of applicator 120 depicted in FIG. 3. The slice of the headbox, when open, deposits additional material onto pulp web 16 or onto the top wire. When the slice of the second headbox is closed, additional material cannot flow out of the second headbox.

Although the daubing dandy or rotogravure-type methods have been discussed above, other methods involving transfer rolls, a four-roll size press or crepeing devices may also be used. The transfer roll method contemplates applying bands at the press roll, the four roll size press contemplates applying bands at the size press, and crepeing contemplates applying microcrepes in normal cigarette paper.

Additionally, it may be desired to produce a pulp web 116 with plurality of cross-directional regions 111 of increased basis weight. An apparatus for effecting this is disclosed in U.S. Pat. No. 5,474,095, the contents of which are hereby incorporated by reference in their entirety.

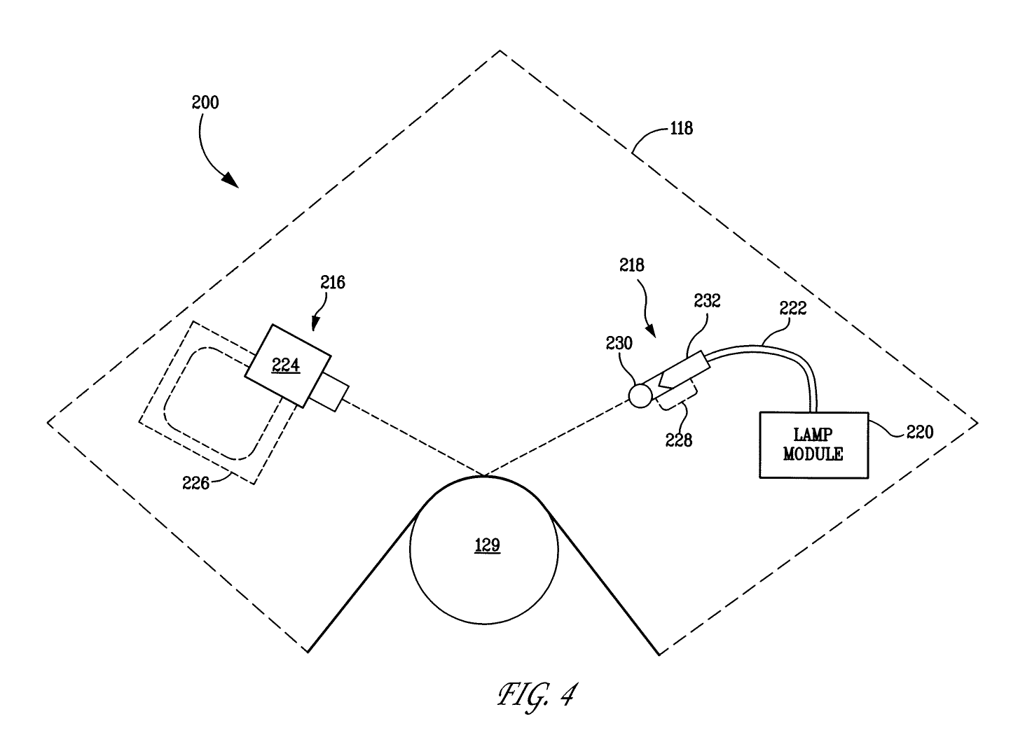

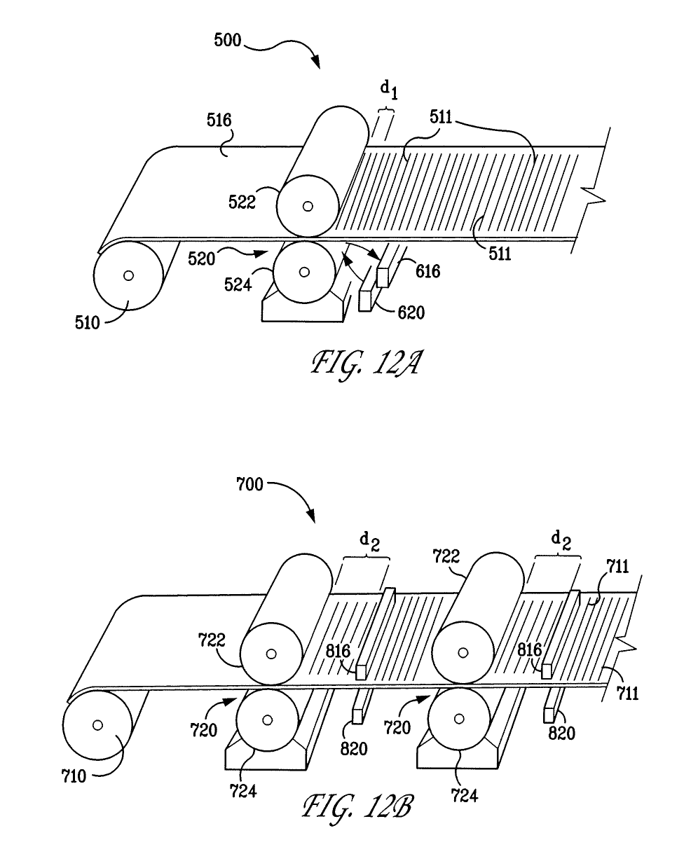

Referring to FIGS. 3 and 4, in operation, the paper is fed over an inspection roller 129 where it is inspected by a line scan camera 216 in conjunction with a light source assembly 218. More specifically, the light source assembly 218 directs light onto the paper as it passes over the inspection roller assembly 129. The light is reflected from, or transmitted through (see FIG. 12B), the paper and received by the camera 216, which contains a linear CCD array. Information from the CCD array is used to characterize the properties of the paper passing over the inspection roller 129.

As may be appreciated, the use of white light requires spectral reflection and the angles presented in white-light-based systems, and the motion inherent in a moving web, have been found to present difficulties in operation. These problems have been found not to exist in the infrared-light-based systems described herein. Moreover, it has been discovered that infrared-light-based systems have utility in both aqueous- and solvent-based add-on material application systems, provided the later includes an effective amount of water in its composition.

In the inspection systems described herein, the emitted light is partially absorbed by the moisture in the freshly applied add-on material. The camera is responsive to the change in intensity of the reflected (or transmitted) light when the emitted light is directed through regions of still-wet add-on material.

Referring to FIG. 4, the camera 216 can be an indium gallium arsenide shortwave infrared focal plane array camera (InGaAs SWIR FPA), such as offered by Sensors Unlimited, Inc. of Princeton, N.J., which operates in the spectral range of 700-1700 nm, or an indium antimonide focal plane array (InSb FPA) camera, such as offered by Santa Barbara Focalplane of Goleta, Calif., that can cover the entire near infrared range and beyond. The spatial resolution of the image is defined by the field of view of each of the sensors (pixels) in the array. These cameras are available with more than 640×512 pixels in the array. The camera electronics controls the recording of the images and can provide time gating. In one form, the data acquisition may be synchronized with the firing of the laser, so that the frame rate will be equal with the pulse repetition rate of the laser. The time gate of the camera can be adjusted to capture each reflected or transmitted signal from the target, as will be described in more detail below.

As shown in FIG. 4, the optical inspection system 200 includes a lamp module 220, such as a 150 watt halogen bulb. The lamp module 220 is preferably located within enclosure 118 (see also FIG. 3). The light generated by the lamp module 220 is channeled to a light distribution assembly 218 via a fiber optic cable 222. The light distribution assembly 218 comprises a light distribution head end 232 for distributing the light laterally across the width of the paper. A rod lens 230 focuses the light from the head end 232 into a narrow stripe of light, which impinges the surface of the paper passing over the inspection roller 129. A bracket mechanism 228 allows the operator to adjust the orientation of the light distribution assembly 218 and thereby alter the angle of the light beam produced thereby.

The light which impinges on the surface of the paper passing over the roller 129 is reflected from, or transmitted through (see FIG. 12B), the surface of the paper. The reflections or transmissions are received by a line scan camera assembly 216. The assembly 16 includes the line scan camera 224 supported by positioning bracket 226. The line scan camera 224 includes a linear array of photoreceptive elements (e.g. comprising a 256×1 array or a 1028×1 array).

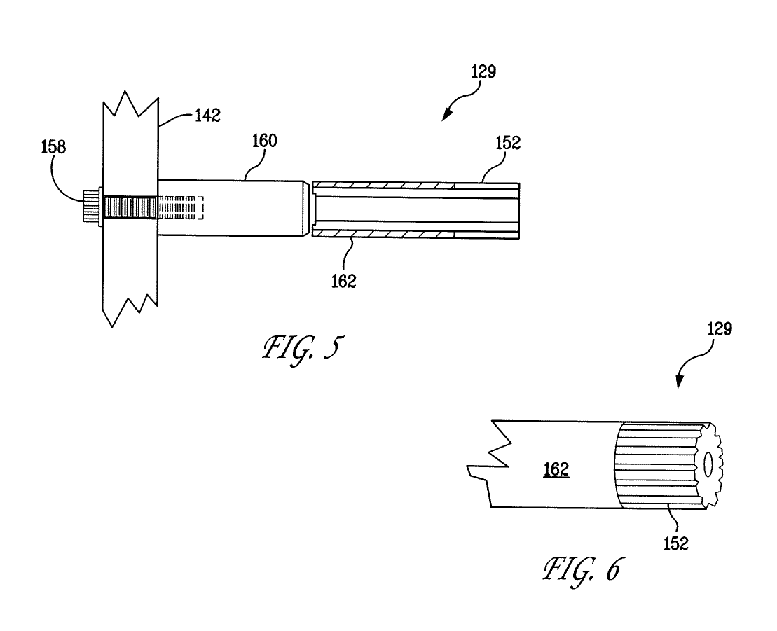

FIGS. 5 and 6 illustrate the inspection roller 129 in more detail. As shown there, the inspection roller 129 includes a rotating cylinder 162 (e.g. containing ball bearings which are not shown) attached to a stationary member 160. The stationary member 160 is, in turn, connected to the back plate 142 by means of bolt 158. The end of the inspection roller 129 includes grooves 152 arranged at regular intervals around the periphery thereof. The line scan camera 224 senses these grooves and the rate at which they move. The rate provides a time base from which the system calculates parameters such as band width and the spacing between bands; in this context, the inspection roller 129 and the camera 224 serve as an encoder.

Those skilled in the art will recognize that other types of encoders can be used to provide the common frame of reference. For instance, a proximity sensor can be used to detect the rate at which a pulse wheel rotates wherein a pulse wheel is mounted to a rotating member. A tachometer can also be used as the encoder.

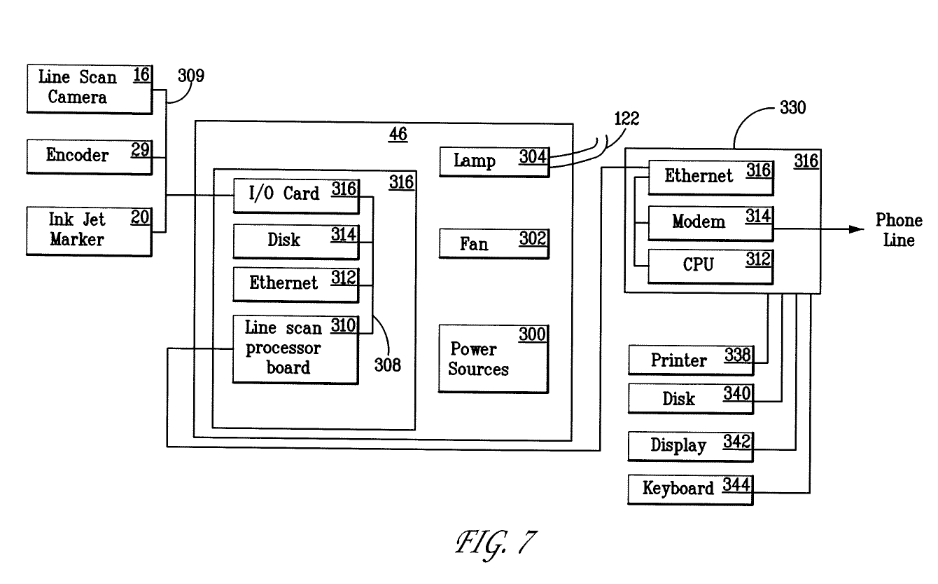

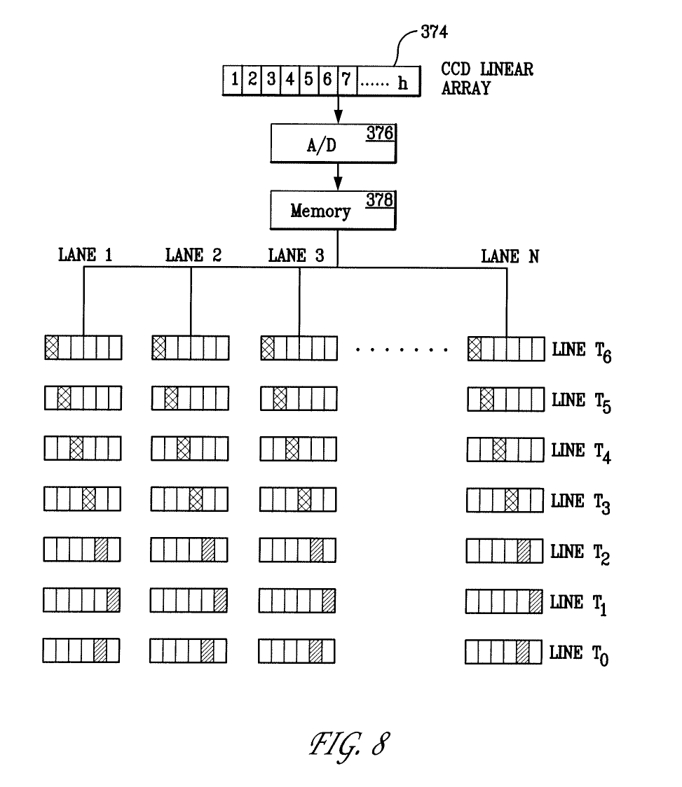

The output of the encoder is also used as a common frame of reference to synchronize various activities in the system. For instance, the encoder can be used to calculate the speed of the paper, which, in turn, allows, for example, a printer 20 (see FIG. 7) to mark the location of irregular bands detected “upstream” by the camera assembly 216. In one form, when the camera assembly 216 detects an irregular band, a timer may be initiated having an initial time value equivalent to the amount of time it takes a portion of the paper to move from the camera assembly 216 to the printer 20. When the timer counts down, the printer 20 prints a mark on the paper at the location of the irregular band. This feature may be particularly advantageous because it allows the operator to revisit the location of anomalies sensed by the camera and further analyze these anomalies. Alternatively, the printer 20 can be disabled if the operator does not want to inspect the irregular portions of the paper.

The majority of the electrical infrastructure may be located in the enclosure 18. A more detailed illustration of the electrical components can be found in FIG. 7.

As shown, the enclosure 118 includes a computer processing module 306 which includes an I/O card 316, a flash disk 314, and Ethernet interface 312 and one or more line scan processor boards 310, all of which are connected together on an internal bus 308. Additionally, the enclosure 118 contains a lamp module 304 for supplying light via fiber optic cable 222 to the light distribution element 218. To cool the components, the enclosure 118 may include one or more fans 302. Finally, the enclosure 118 may include one or more power sources 300 for supplying appropriate power to the various components.

The processing module 306 of the optical inspection system interacts with various components, including the line scan camera 216, encoder 129, and printer or marker 20. These components can be connected to the processing module 306 via their own dedicated lines (not shown) or a common control bus 309. Other components may also be employed, which will be readily apparent to those skilled in the art.

The Ethernet interface 312 of the processing module 306 provides connection to an Ethernet interface 332 of workstation 330. The workstation 330 includes a modem 334 for transferring information to a remote computer (not shown) over a phone line, and a controlling CPU 336. The workstation has associated therewith the following peripheries: printer 338, disk 340, display 342, and keyboard 344.

The optical inspection system employing short wave infrared sensing discussed above has many applications. As mentioned, the optical inspection system is especially well adapted to detecting anomalies in cigarette paper having bands, as will be discussed at length as follows.

Commonly assigned U.S. Pat. Nos. 5,417,228 and 5,474,095 disclose cigarette papers comprising a base web and banded regions of add-on material. For instance, returning to FIG. 1, an exemplary cigarette 10 contains two bands 14 formed by depositing a layer of pulp on base cigarette paper 12. Cellulon, microcrystalline cellulose, flax or wood pulp, or amylopectin are some of the various substances that have been used to form the bands. Commonly assigned U.S. Pat. No. 5,534,114 discloses that the above described bands can be formed by modifying a conventional Fourdrinier paper making machine to deposit additional layers of cellulose at some stage in the production of the cigarette base paper 12. To streamline the process, the bands are preferably applied while the paper is moving at high speeds, such as 500 feet per minute. At these high speeds, breakdowns and other factors (such as clogged band applicators), can result in the production of irregular bands.

For example, as illustrated in FIG. 2, common irregularities arise when the width of a band 16 deviates from a desired width, or the band becomes skewed so that it is no longer orthogonal with respect to the edge of the paper. Other irregularities arise when the separation between two bands 18 deviates from a desired separation width. Moreover, a given band applicator can produce a band with gaps or a band having a contrast which is either too high or too low. The optical inspection system employing short wave infrared sensing can be employed for monitoring the band width, band spacing and band contrast.

More specifically, the camera 216 can employ a 256×1 CCD array (element 374 with reference to FIG. 8), which receives reflections or transmissions (see FIG. 12B) which span the lateral dimension of the web passing over the inspection roller 129. The exemplary resolution of the array in the lateral direction across the roller 129 is 0.2 mm. Furthermore, the CCD array is exposed at a rate which allows the computer to sample information at a resolution of 0.2 mm in the longitudinal direction. Thus, the array effectively samples elements having a spatial dimension on the paper of 0.2 mm×0.2 mm. Accordingly, each element of the CCD array includes a value indicative of the magnitude of the reflection or transmission sensed in a 0.2 mm×0.2 mm portion of the moving web.

The data from the linear array is thereafter converted from analog to digital form in AID converter 376 and stored in memory 378 of one of the scan processor boards 310. The processor 306 then divides the data from each array into a series of contiguous lanes (e.g. a total of 32 lanes in one form). To facilitate discussion, each lane shown in FIG. 8 comprises 6 contiguous pixel elements, although each lane will typically include many more pixels. The magnitude of each pixel is quantified into one of 255 different levels.

During each exposure, a single pixel from each lane is compared with a dynamic threshold. Pixels above the given threshold are indicative of banded regions of the web, while pixels below the given threshold are marked as non-banded regions. Upon the next exposure, the next contiguous pixel in the lane is exposed, and the comparison is repeated. For example, at an arbitrary time denoted t₀, the fifth pixel in each lane is compared with the dynamic threshold (e.g. see bottom-most row of lanes denoted as “line t₀”). In the next exposure, the sixth element is compared to the threshold (e.g. see the rows of lanes denoted as “line t₁”). After this, the system will continue back in the opposite direction, choosing the fifth pixel for comparison with the threshold in line t₂. Thus, the pixel chosen for comparison with the threshold varies in a serpentine path, as generally denoted by FIG. 8. According to another form, the inspected pixel is not advanced at each line. Rather, in this form, the processing module dwells on each pixel for a prescribed number of lines (e.g. corresponding to 30 mm), after which it will advance to a next adjacent pixel. The comparison of only one pixel out of each lane enhances processing speed without significantly degrading performance.

The pixel elements marked with an “X” denote a pixel value above the dynamic threshold. Thus, it is seen that a band started at line t₃.

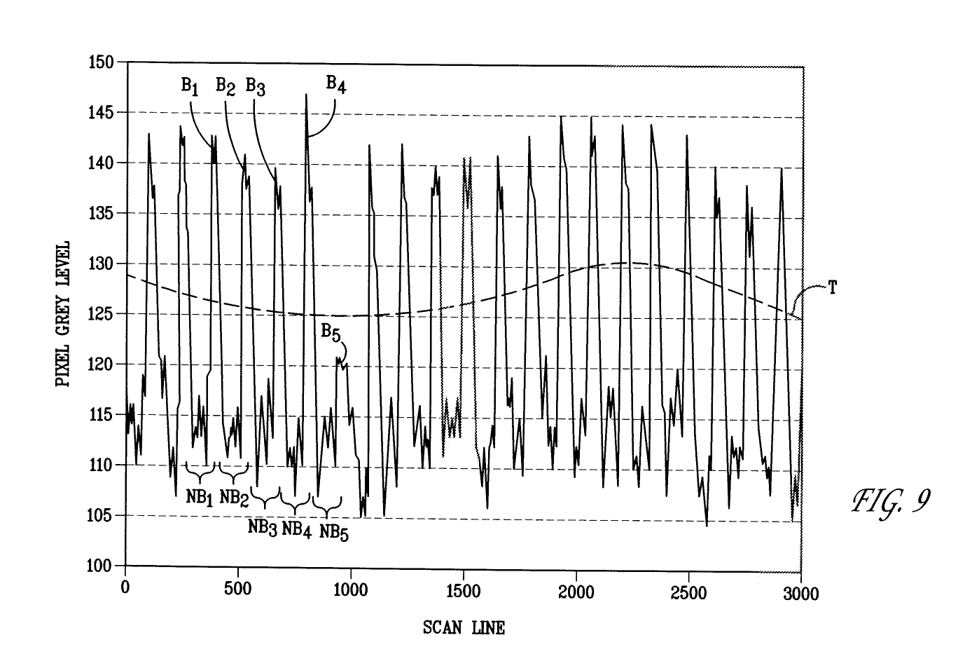

The threshold used to detect a band region and a non-band region is dynamic in the sense that it varies to accommodate changes in the base paper, band material, or measuring environment. For instance, as shown in FIG. 9, an exemplary waveform of pixel gray level as a function of scan line shows local perturbations which represent transitions from background non-banded regions (e.g. as in regions NB₁, NB₂, NB₃, Naₜ and NB₅) to banded regions (e.g. as in regions B₁, B₂, B₃, B₄ and B₅). The waveform also shows a global change in which the general baseline of these local perturbations slowly undulates. For example, the global undulation is at its lowest point around the scan line 1000, and at its highest point around scan line 2000. This global undulation is primarily due to changes in the basis weight of paper caused by uneven application of pulp by the paper making machine. The system disclosed herein takes this phenomenon into account by adjusting the threshold level (T) so that it generally tracks the changing baseline of the waveform.

One technique for dynamically varying the threshold level is described as follows. Generally, the threshold at any given moment is a function of the gray levels of the immediately preceding band region or regions, and the gray levels of the immediately preceding non-band region or regions. In one form, the threshold represents a moving average of previous non-band background (e.g. an average of NB₁, NB₂, etc.) plus the greater of (1) a set constant (such as 10 gray levels), or (2) 50% of the moving average of peak heights of the banded regions (e.g. an average of the heights of B₁, B₂, etc.). For example, consider the band region B₃. The threshold used to discriminate this band region is determined by first calculating the average background level of the non-band regions NB₂, NB₃. Thereafter, an average peak height value is determined by computing the average of the heights of the B₁, B₂ band regions. The “height” of a band region generally corresponds to the difference in pixel gray level between the band region and a subsequent non-band region. In making this measurement, a single gray level can be used to represent the gray level of the band region (such as the maximum gray level), or an average of gray levels within the band region can be used. Similarly, a single gray level can be used to represent the gray level of a subsequent non-banded region, or an average of gray levels within the subsequent non-banded region can be used. After computing the peak heights in this manner, half of the average peak heights (e.g. from B₁, B₂) is compared with the preset value. The greater of the two is added to the average background level (computed above) to derive the threshold value. For example, the average of the heights of B₁, B₂ is approximately 30 gray levels, half of which is 15 gray levels. If the preset value is set at 10 gray level values, then the algorithm will select 15 as the value to be added to the average background. However, if a series of shorter peaks (such as B₅) are encountered, then the algorithm will rely on the preset value (e.g. of 10 gray levels) to discriminate band regions from non-band regions. The preset value may be set at least high enough so that noise in the non-banded region will not be misinterpreted as the start of a band region.

It will be readily apparent to those skilled in the art that the window selected for calculating the moving average of peak heights and non-banded region levels need not be restricted to two banded regions and two non-banded regions, respectively. A smoother threshold can be obtained by widening the window. Furthermore, the above discussed threshold levels are dependent on the type of paper and the band material used, as well as the operating environment; the specific values cited above are entirely exemplary.

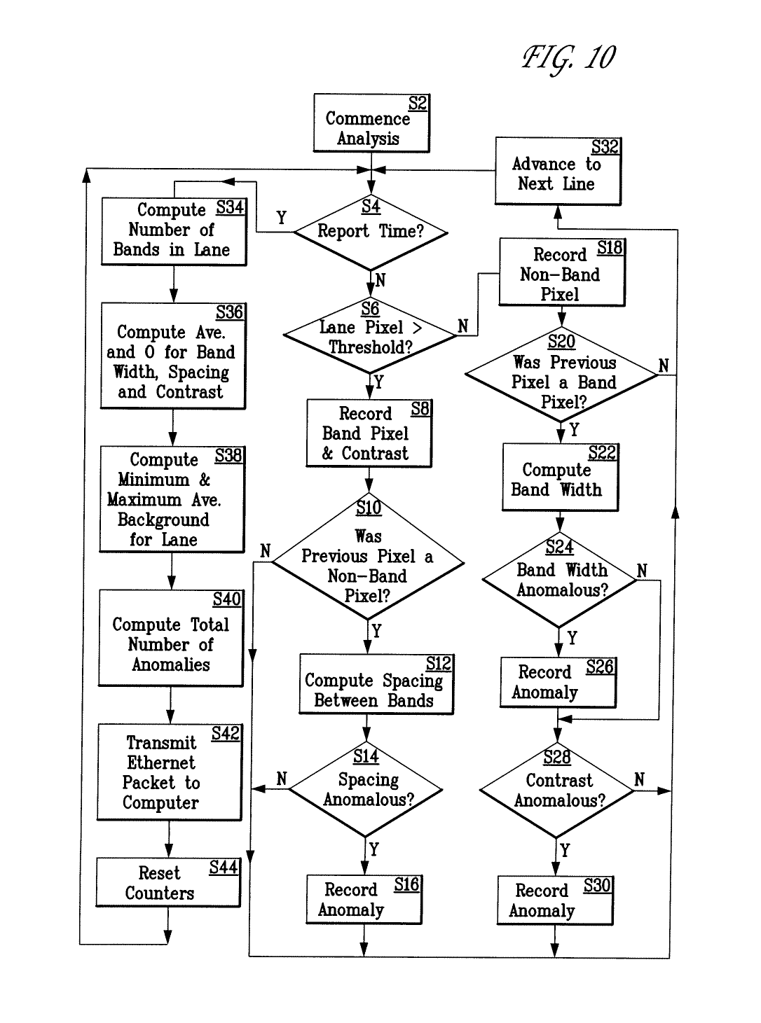

The actual task of determining the characteristics of the bands can be understood with reference to the flowchart shown in FIG. 10. The analysis commences at step S2, followed by a determination whether it is time to report data from the processing board 310 to the workstation 330 over the Ethernet network (step S4). In one form, the processing performed by board 310 is reported every half second (or every 1/10 of a second for timelier reporting). Having just commenced analysis, the results of this query will be answered in the negative, and the system will advance to step S6. In step S6 it is ascertained whether the pixel in a lane is above the dynamic threshold. To facilitate discussion, step S6 is framed in the context of a single lane. However, it should be kept in mind that the output of each array is divided into a plurality of lanes. Thus the comparison shown in step S6 is in actuality repeated many times for different lanes. In one form, the processing board 310 performs the computations for different lanes in parallel to improve processing speed.

If it is determined in step S6 that the magnitude of the pixel is above a dynamic threshold, then the algorithm advances to step S8, where the presence of a banded pixel and its contrast are recorded. If the previous pixel in the previous line was not a band pixel (as determined in step S10), then the current line represents a start of a band. This would correspond to line t₃ shown in FIG. 8, since the previous line at t₂ contained a pixel below the dynamic threshold. It is therefore possible at this time to determine whether the spacing between the present band and the last encountered band (if appropriate) is within prescribed tolerances (steps S12 and S14). If the band spacing is either too long or too short, this fact is logged in step S16, whereupon the algorithm advances to the next line in step S32.

If, on the other hand, the pixel examined in step S6 is below the dynamic threshold, then this fact is recorded in step S18. It is then determined if the previous examined pixel in the previous line was a band pixel (step S20). If so, this marks the end of a band, and it is then possible to determine the average contrast of the band and the width of the band (step S22). It is determined whether these values are outside of prescribed tolerances (steps S24-S30). If so, these anomalies are recorded and the algorithm advances to the next line in step S32.

Suppose at this time, it is determined that a half of a second has elapsed (in step S4). This causes the line scan processor 310 to enter its report mode. As shown in FIG. 10, the processor 310 will compute the number of bands in the lane over the last half of a second (step S34), the average and standard deviation for band width, band spacing and band contrast (step S36), the minimum and maximum average background for the lane (step S40) and the total number of anomalies (e.g. out of tolerance band width, spacing and contrast) (step S40). This information is assembled into a packet which is forwarded to the workstation 330, and then the various counters used to compute the totals are reset (in step S44).

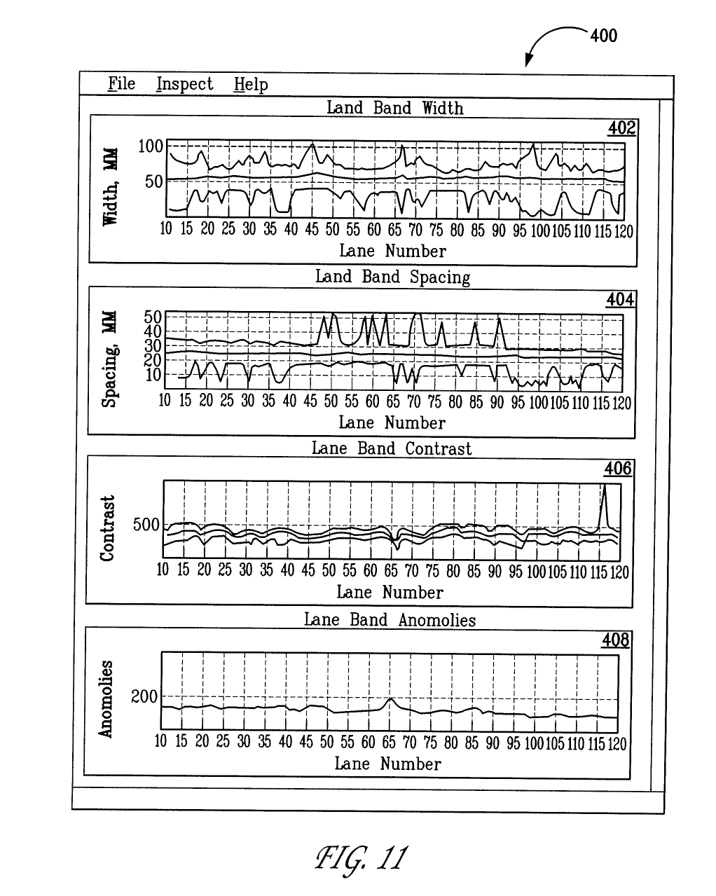

The workstation 330 then aggregates this information with previously transmitted information to provide a statistical summary of the quality of the paper. This information may be displayed on display panel 400 as illustrated in FIG. 11. The panel 400 includes a first subpanel 402 listing the band width as a function of lane number for the last reporting interval. A subpanel 404 illustrates band spacing as a function of lane number for the last reporting interval. A subpanel 406 illustrates band contrast as a function of lane number of the last reporting interval. Finally, subpanel 408 illustrates the number of band anomalies (aggregate of band spacing, band width, and contrast anomalies) as a function of lane number for the last reporting interval. The subpanels 402, 404 and 406 contain a middle line indicating the average values of the band width, band spacing and band contrast over the half second interval of reporting. The two other curves bracketing the middle curves denote the plus and minus 3a readings. The middle curve can be shown in green, while the 3a curves are shown in red so that they can be more readily distinguished.

In addition to the current lane summary, the workstation 330 provides statistics summarizing various characteristics of the operation. Notably, subpanel 410 illustrates the composite band width (e.g. the average bandwidth) as a function of time. Subpanel 412 illustrates composite band spacing 412 as a function of time. Finally, subpanel 414 shows composite band contrast as a function of time. Thus, with the right-hand subpanels, it is possible to observe any trends in degradation. With the left-hand subpanels, it is possible to observe specific points in the lateral span of the web which are producing out-of-tolerance bands, band-spacing or band contrast, which may be caused by clogged pulp applicators.

In addition to these graphs, the workstation 330 may present information regarding the roll length, the velocity of the web (from the encoder or a tachometer) and a sample id (which the user enters in advance to label the run). All of the above data can be stored for further non-real-time analysis. The run may be indexed by the id number.

The interface software of the workstation 330 additionally includes routines to monitor system parameters to determine system status. When an anomaly is detected, the operator interface will display a message identifying the most-likely cause of the anomaly. In the panel 417 shown in FIG. 11, the message indicates that the lamp 120 (of FIG. 8) is currently functional.

Referring now to FIG. 12A, in yet another form, a roll of cigarette paper 510 (base web 516) is converted to banded paper utilizing application techniques such as gravure printing or the like. In the gravure system depicted schematically, paper is drawn from a roll 510, along a path (“web path”) which extends through one or more print stations 520 and drying sections (not shown). Each print station 520 includes a gravure roller 522, which applies add-on maternal to one side of the base web 516 and a backup roller 524.

A source of infra red light 620 and one or more infrared cameras 616 are arranged immediately downstream of each print station 520. The light source 620 and camera(s) 616 are mutually arranged adjacent the respective print station 520 so that the infrared light emitted by the source 620 strikes the paper just after it has passed through the respective print station 520 and is reflected toward the camera 616.

Referring now to FIG. 12B, in yet another form, a roll of cigarette paper 710 (or base web 716) is converted to banded paper, again utilizing application techniques such as gravure printing or the like. The paper is again drawn from a roll 710, along a path (“web path”) which extends through one or more print stations 720 and drying sections (not shown). Each print station 720 includes a gravure roller 722, which applies add-on maternal to one side of the base web 716, and a backup roller 724.

In the form depicted herein, a source of infra red light 820, and one or more infrared cameras 818 are arranged immediately downstream of each print station 720. The light source 820 and camera(s) 816 are mutually arranged adjacent the respective print station 720 so that the infrared light emitted by the source 820 strikes the paper just after it has passed through the respective print station 720 and is transmitted through the web 716 and toward the camera 816.

As may be appreciated, the camera employed is conducive to detecting a difference in reflectance (or alternatively, or in conjunction, transmission) between banded regions of freshly applied add-on material, which are still wet, and the regions of the base web 516, 716 which are free of add-on material (and is in a dried, un-wetted state). The cameras described hereinabove possess those capabilities. In the forms depicted in FIGS. 12A and 12B, data collection, analysis and presentation may be carried out as hereinabove described. As shown in FIGS. 12A and 12B, the distances d₁, d₂ that light sources 620, 720 and their respective cameras 616, 716 are placed from each print station 520, 720 are not critical, so long as the banded regions of freshly applied add-on material are still wet and capable of generating a difference in reflectance or transmission between banded regions and the regions of the base web that are free of add-on material.

By way of example, the present invention has been described in the context of detecting bands formed on cigarette paper. But the present invention extends to the detection of any information formed on sheet-like material.

All patents, test procedures, and other documents cited herein, including priority documents, are fully incorporated by reference to the extent such disclosure is not inconsistent with this disclosure and for all jurisdictions in which such incorporation is permitted.

While the illustrative forms disclosed herein have been described with particularity, it will be understood that various other modifications will be apparent to and can be readily made by those skilled in the art without departing from the spirit and scope of the disclosure. Accordingly, it is not intended that the scope of the claims appended hereto be limited to the examples and descriptions set forth herein but rather that the claims be construed as encompassing all the features of patentable novelty which reside herein, including all features which would be treated as equivalents thereof by those skilled in the art to which the disclosure pertains.

What is claimed is:

1. A system for inspecting cigarette paper containing banded regions and non-banded regions, comprising:
a) a short wave infrared camera, said short wave infrared camera forming electrical signals representing properties of said cigarette paper; and
b) a processor for analyzing said electrical signals to provide analysis results, said processor including logic for successively examining pixels to determine whether each successive pixel corresponds to a non-banded region or a banded region; logic for computing spacing between adjacent banded regions on said cigarette paper based on results provided by said logic for successively examining; and logic for computing width of banded regions on said cigarette paper based on results provided by said logic for successively examining.

2. The system of claim 1, wherein said short wave infrared camera includes indium gallium arsenide sensors.

3. The system of claim 1, wherein said processor's analysis results additionally comprise computation of contrast of banded regions on said cigarette paper.

4. The system of claim 1, wherein said processor periodically transfers said analysis results to a computer, which displays said analysis results.

5. The system of claim 4, wherein said computer aggregates a plurality of reported analysis results, and presents a statistical summary of said analysis results.

6. The system of claim 1, further including an encoder for sensing web speed.

7. The system of claim 6, further including a printer for printing information on said paper by reference to output of said encoder.

8. A system for inspecting cigarette paper containing banded regions and non-banded regions, comprising:
a) a short wave infrared camera, said short wave infrared camera forming electrical signals representing properties of said cigarette paper; and
b) a processor for analyzing said electrical signals to provide analysis results, said processor including logic for dividing said electrical signals of said camera into a plurality of lanes, and examining electrical signals within each output lane to determine whether the electrical signals are above or below a threshold, wherein electrical signals above said threshold are indicative of said banded regions, and electrical signals below said threshold are indicative of said non-banded regions of said cigarette paper.

9. The system of claim 8, wherein said threshold is computed as a function of a moving average of gray level values within one or more non-banded regions, and a moving average of relative gray level values within one or more banded regions.

10. A system for inspecting cigarette paper containing banded regions and non-banded regions, comprising:
a) a short wave infrared camera, said short wave infrared camera forming electrical signals representing properties of said cigarette paper; and
b) a processor for analyzing said electrical signals to provide analysis results, said processor discriminating non-banded regions from banded regions using a dynamic threshold.

11. The system of claim 10, wherein said dynamic threshold is computed as a function of a moving average of gray level values within one or more non-banded regions, and a moving average of relative gray level values within one or more banded regions.

12. A method for inspecting paper containing banded regions and non-banded regions, including the steps of:
a) directing light from a light source to the surface of the paper, the light forming reflections from or transmissions through the paper;
b) receiving the reflections or transmissions by a short wave infrared camera to generate output signals; and
c) processing the output signals in a processing module to generate output information representative of one or more of the following properties; i) width of one or more banded regions; ii) spacing between one or more adjacent sets of banded regions; and iii) contrast of one or more banded regions.

13. The method of claim 12, wherein the processing module generates the output information by: successively examining pixels to determine whether each successive pixel corresponds to a non-banded region or a banded region; computing spacing between adjacent banded regions on the cigarette paper based on results provided by the step of successively examining; and computing width of banded regions on the cigarette paper based on results provided by the step of successively examining.

14. The method of claim 13, further including the step of periodically transferring the output information to a computer, which displays the output information.

15. The method of claim 14, wherein the computer aggregates a plurality of reported output information, and presents a statistical summary of the output information.

16. The method of claim 15, wherein the short wave infrared camera includes indium gallium arsenide sensors.

17. The method of claim 12, wherein the short wave infrared camera includes indium gallium arsenide sensors.

18. An online method for inspecting paper containing banded regions and non-banded regions, including the steps of:
a) directing light from a light source to the surface of the paper, the light forming reflections from or transmissions through the paper;
b) receiving the reflections or transmissions by a short wave infrared camera to generate output signals; and
c) processing the output signals in a processing module to generate output information representative of one or more of the following properties: (i) width of one or more banded regions; (ii) spacing between one or more adjacent sets of banded regions; and (iii) contrast of one or more banded regions; and
wherein said processing step further includes the steps of: dividing the output signals of the camera into a plurality of lanes; and examining output signals within each lane to determine whether the output signals are above or below a threshold, wherein output signals above the threshold are indicative of the banded regions, and output signals below the threshold are indicative of the non-banded regions of the cigarette paper.

19. The method of claim 18, wherein the threshold is computed as a function of a moving average of gray level values within one or more non-banded regions, and a moving average of relative gray level values within one or more banded regions.

20. The method of claim 18, wherein the short wave infrared camera includes indium gallium arsenide sensors.

21. The system of claim 1, further comprising a source of infra red light, wherein said source of infra red light and said short wave infrared camera are mutually arranged downstream of an applicator that deposits add-on material for forming the banded regions to enable the detection of differences in reflectance and/or transmission between the banded regions of add-on material, which are in a wet condition, and the non-banded regions, which are free of add-on material.

22. The system of claim 8, further comprising a source of infra red light, wherein said source of infra red light and said short wave infrared camera are mutually arranged downstream of an applicator that deposits add-on material for forming the banded regions to enable the detection of differences in reflectance and/or transmission between the banded regions of add-on material, which are in a wet condition, and the non-banded regions, which are free of add-on material.

23. The system of claim 10, further comprising a source of infra red light, wherein said source of infra red light and said short wave infrared camera are mutually arranged downstream of an applicator that deposits add-on material for forming the banded regions to enable the detection of differences in reflectance and/or transmission between the banded regions of add-on material, which are in a wet condition, and the non-banded regions, which are free of add-on material.

24. The method of claim 12, wherein the light source and the short wave infrared camera are mutually arranged downstream of an applicator for depositing add-on material for forming the banded regions to enable the detection of differences in reflectance and/or transmission between the banded regions of add-on material, which are in a wet condition, and the non-banded regions, which are free of add-on material.

25. The method of claim 18, wherein the light source and the short wave infrared camera are mutually arranged downstream of an applicator for depositing add-on material for forming the banded regions to enable the detection of differences in reflectance and/or transmission between banded regions of add-on material, which are in a wet condition, and the non-banded regions, which are free of add-on material.
